(19) United States
(12) Patent Application Publication
(10) Pub. No.: US 2006/0266219 A1
(43) Pub. Date: Nov. 30, 2006

(54) Metal hydride hydrogen storage system

(75) Inventors: Stanford R. Ovshinsky, Bloomfield Hills, MI (US); Vitaliy Myasnikov, West Bloomfield, MI (US); Alexander Gerasimov, West Bloomfield, MI (US); Valerie Sobolev, Waterford, MI (US)

Correspondence Address: ENERGY CONVERSION DEVICES, INC., 2956 WATERVIEW DRIVE, ROCHESTER HILLS, MI, 48309, US

(73) Assignee: Texaco Ovonic Hydrogen Systems LLC

(21) Appl. No.: 11/182,194

(22) Filed: Jul. 14, 2005

Related U.S. Application Data
(63) Continuation-in-part of application No. 11/138,864, filed on May 26, 2005.

(51) Int. Cl. B01D 53/02

(52) U.S. Cl. 96/108

(57) ABSTRACT

A metal hydride hydrogen storage unit utilizing compartmentalization to maintain a uniform metal hydride powder density thereby reducing stress on the vessel due to repeated cycling. An hydrogen storage alloy powder occupies at least 60% of the available interior volume of the hydrogen storage unit. Upon cycling of the hydrogen storage alloy powder between hydriding and dehydriding, the rate of increase in the average equivalent pressure exerted on the sidewall is less than 25 psi over at least 20 cycles, the hydriding portion of each of the cycles including the step of charging said hydrogen storage alloy powder to at least 60% of its maximum storage capacity.

### CROSS REFERENCE TO RELATED APPLICATIONS

The present application is a continuation-in-part of, and is entitled to the benefit of the earlier filing date and priority of, co-pending U.S. patent application Ser. No. 11/138,864, which is assigned to the same assignee as the current application, entitled “MODULAR METAL HYDRIDE HYDROGEN STORAGE SYSTEM,” filed May 26, 2005 for Myasnikov et al., the disclosure of which is hereby incorporated by reference.

### FIELD OF THE INVENTION

The present invention generally relates to hydrogen storage systems. More particularly, the present invention relates to hydrogen storage systems utilizing a hydrogen storage alloy to store hydrogen in metal hydride form.

### BACKGROUND

In the past considerable attention has been given to the use of hydrogen as a fuel or fuel supplement. While the world's oil reserves are rapidly being depleted, the supply of hydrogen remains virtually unlimited. Hydrogen can be produced from coal, natural gas and other hydrocarbons, or formed by the electrolysis of water. Moreover hydrogen can be produced without the use of fossil fuels, such as by the electrolysis of water using renewable energy. Furthermore, hydrogen, although presently more expensive than petroleum, is a relatively low cost fuel. Hydrogen has the highest density of energy per unit weight of any chemical fuel and is essentially non-polluting since the main by-product of burning hydrogen is water.

While hydrogen has wide potential application as a fuel, a major drawback in its utilization, especially in mobile uses such as the powering of vehicles, has been the lack of acceptable hydrogen storage medium. Conventionally, hydrogen has been stored in a pressure vessel under a high pressure or stored as a cryogenic liquid, being cooled to an extremely low temperature. Storage of hydrogen as a compressed gas involves the use of large and bulky vessels.

Additionally, transfer is very difficult, since the hydrogen is stored in a large-sized vessel; amount of hydrogen stored in a vessel is limited, due to low density of hydrogen. Furthermore, storage as a liquid presents a serious safety problem when used as a fuel for motor vehicles since hydrogen is extremely flammable. Liquid hydrogen also must be kept extremely cold, below −253° C., and is highly volatile if spilled. Moreover, liquid hydrogen is expensive to produce and the energy necessary for the liquefaction process is a major fraction of the energy that can be generated by burning the hydrogen.

Alternatively, certain metals and alloys have been known to permit reversible storage and release of hydrogen. In this regard, they have been considered as a superior hydrogen-storage material, due to their high hydrogen-storage efficiency. Storage of hydrogen as a solid hydride can provide a greater volumetric storage density than storage as a compressed gas or a liquid in pressure tanks. Also, hydrogen storage in a solid hydride presents fewer safety problems than those caused by hydrogen stored in containers as a gas or a liquid. Solid-phase metal or alloy system can store large amounts of hydrogen by absorbing hydrogen with a high density and by forming a metal hydride under a specific temperature/pressure or electrochemical conditions, and hydrogen can be released by changing these conditions. Metal hydride systems have the advantage of high-density hydrogen-storage for long periods of time, since they are formed by the insertion of hydrogen atoms to the crystal lattice of a metal. A desirable hydrogen storage material must have a high gravimetric and volumetric density, a suitable absorption/desorption temperature/pressure, good kinetics, good reversibility, resistance to poisoning by contaminants including those present in the hydrogen gas and be of a relatively low cost. If the material fails to possess any one of these characteristics it will not be acceptable for wide scale commercial utilization.

Good reversibility is needed to enable the hydrogen storage material to be capable of repeated absorption-desorption cycles without significant loss of its hydrogen storage capabilities. Good kinetics are necessary to enable hydrogen to be absorbed or desorbed in a relatively short period of time. Resistance to contaminants to which the material may be subjected during manufacturing and utilization is required to prevent a degradation of acceptable performance.

Heat transfer capability can enhance or inhibit efficient exchange of hydrogen into and out of hydrogen storage metal alloys used in hydride storage systems. During hydriding of the hydrogen storage alloy an exothermic reaction occurs whereby hydrogen is absorbed into the hydrogen storage alloy and during dehydriding of the hydrogen storage alloy an endothermic reaction occurs whereby hydrogen is desorbed from the hydrogen storage alloy. In many instances, heat transfer within the hydrogen storage alloy utilized in the hydrogen storage systems cannot be relied upon for effective heat transfer within the hydrogen storage system since metal hydrides, in their hydrided state, being somewhat analogous to metal oxides, borides, and nitrides (“ceramics”), may be considered to be generally insulating materials. Therefore, moving heat within such systems or maintaining preferred temperature profiles across and through volumes of such storage materials becomes a crucial factor in metal alloy-metal hydride hydrogen storage systems. As a general matter, release of hydrogen from the crystal structure of a metal hydride requires input of some level of energy, normally heat. Placement of hydrogen within the crystal structure of a metal, metal alloy, or other storage system generally releases energy, normally heat, providing a highly exothermic reaction of hydriding or placing hydrogen atoms within the crystal structure of the hydrideable alloy.

The heat released from hydrogenation of hydrogen storage alloys must be removed. Heat ineffectively removed can cause the hydriding process to slow down or terminate. This becomes a serious problem which prevents fast charging. During fast charging, the hydrogen storage alloy is quickly hydrogenated and considerable amounts of heat are produced. The present invention provides for effective removal of the heat caused by the hydrogenation of the hydrogen storage alloys to facilitate fast charging of the hydride material.

Due to the heat input and heat dissipation needs of such systems, particularly in bulk, and in consideration of the insulating nature of the hydrided material, it is useful to provide means of heat transfer external to the storage material itself. Others have approached this in different ways, one by inclusion of a metal-bristled brush or brush-like structure within the hydrogen storage alloy powder, depending upon the metal bristles to serve as pathways for effective heat transfer. Another has developed a heat-conductive reticulated open-celled “foam” into which the hydrided or hydrideable material is placed.

Another recognized difficulty with hydride storage materials is that as the hydrogen storage alloy is hydrided, it will generally expand and the alloy particles will swell and, often crack. When hydrogen is released, generally on application of heat, the storage material or hydrided material will shrink and some particles may collapse. The net effect of the cycle of repeated expansion and contraction of the storage material is comminution of the alloy or hydrided alloy particles into successively finer grains.

The comminution process results in a decrease in the powder density of the storage material. The powder density depends on the density of the individual particles that make up the powder as well as the spatial arrangement of the particles within the powder. When the individual particles are arranged in a less packed configuration, the powder density is lower than when the same particles are arranged in a packed configuration. The expansion of the hydrogen storage alloy that occurs upon hydriding includes a contribution from an expansion of individual particles as hydrogen is absorbed (this contribution results from an increase in the unit cell dimensions of the particles) and a contribution due to an accompanying rearrangement of particles needed to accommodate the expanding particles. Upon dehydriding, the individual particles contract to their original density as hydrogen is released, but the relative positions of the particles do not revert back to the positions they occupied prior to hydriding. As a result, the net effect of a cycle of hydriding and dehydriding is a reduction in the powder density of the hydrogen storage alloy.

The powder density continues to decrease upon multiple hydriding-dehydriding cycles until a limiting powder density is reached. When stored in a pressure containment vessel at constant volume, the decreasing powder density increases the stress on the interior wall of the pressure containment vessel. The limiting powder density and the number of cycles needed to achieve it is a characteristic of the particular hydrogen storage alloy subjected to cycling.

While comminution may be generally beneficial to the enhancement of overall surface area of the alloy or storage material surface area, it creates the possibility that the extremely fine particles may sift through the bulk material and settle toward the lower regions of their container or shift by gas flow and pack more tightly in localized areas than is desirable. Highly packed localized high density regions of hydrogen storage alloy powder within a hydrogen storage vessel are undesirable because they may produce a great amount of stress on the vessel upon further hydriding cycles as the high local packing density of fine particles resists the rearrangement of particles that would otherwise occur as the individual particles expand during absorption of hydrogen. As a result, the force of expansion is increasingly directed externally toward the vessel wall and leads to the development of local stresss. The magnitude of such local stresss increases with the number of hydriding-dehydriding cycles and can lead to deformation, cracking and rupture of the vessel wall.

While including heat transfer and/or compartmentalization structures in a metal hydride hydrogen storage system has many benefits, the inclusion of such structures is not without problems. The heat transfer and/or compartmentalization structures, due to their size with respect to allowable vessel openings, can be difficult to properly position into prefabricated seamless pressure containment vessels. As such, prefabricated vessels are not typically utilized for hydrogen storage units containing such structures. A two piece pressure containment vessel may be used to house the hydrogen storage alloy powder, however, after the heat transfer/compartmentalization structures are placed inside the two pieces and the two pieces are welded together to form the vessel, a seam is formed which may provide weakness to the vessel structure. To place the heat transfer/compartmentalization structures within a seamless pressure containment vessel, a pressure containment vessel may be formed around the heat transfer/compartmentalization structures utilizing a spinning process, but this process can be timely and may increase the production cost of the system. The ability to purchase prefabricated pressure containment vessels in bulk then place the heat transfer/compartmentalization structures within the prefabricated vessels can be a cost effective way of constructing metal hydride hydrogen storage units and is highly desirable.

### SUMMARY OF THE INVENTION

Disclosed herein, is a metal hydride hydrogen storage unit comprising a pressure containment vessel having a longitudinal axis, a plurality of cells at least partially filled with a hydrogen storage alloy powder, a plurality of primary modular blocks containing at least a portion of the plurality of cells, and a plurality of fins wherein each of the fins are disposed between two of the primary modular blocks. The plurality of modular blocks and/or the plurality of fins may be radially disposed inside the pressure containment vessel about the longitudinal axis of the pressure containment vessel. The plurality of fins may have a corrugated or grooved configuration. The plurality of cells may have an open top, an open bottom, and a cell wall. The hydrogen storage material may be retained in the plurality of cells via a porous filter material disposed at the top and/or bottom of each of the plurality of cells. The plurality of cells may have a circular configuration or a polygonal configuration. The primary modular blocks preferably have a height less than one half of the inner diameter of the pressure containment vessel. The pressure containment vessel may be wrapped in a fiber reinforced composite material.

The metal hydride hydrogen storage unit may further comprise one or more heat exchanger tubes at least partially disposed within the pressure containment vessel, the one or more heat exchanger tubes being in thermal communication with the hydrogen storage material.

The metal hydride hydrogen storage unit may further comprise an axial channel disposed about the longitudinal axis of the pressure containment vessel. One or more secondary blocks including at least a portion of the plurality of cells may be disposed in the axial channel. The one or more secondary modular blocks may have a cylindrical configuration.

In a first embodiment of the present invention, a hydrogen storage material occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 25 psi over at least 20 of the cycles, the hydriding portion of each of the cycles including the step of charging said hydrogen storage material to at least 60% of its maximum storage capacity. Preferably, the rate of increase of equivalent pressure exerted on the sidewall is less than 25 psi per cycle of hydriding and dehydriding over at least 45 of the cycles. More preferably, the rate of increase of equivalent pressure exerted on the sidewall is less than 25 psi per cycle of hydriding and dehydriding over at least 65 of the cycles. Preferably, the hydriding portion of each cycle includes the step of charging the hydrogen storage material to at least 75% of its maximum storage capacity. More preferably, the hydriding portion of each cycle includes the step of charging the hydrogen storage material to at least 90% of its maximum storage capacity.

In a second embodiment of the present invention, a hydrogen storage material occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 15 psi over at least 20 of the cycles, the hydriding portion of each of the cycles including the step of charging said hydrogen storage material to at least 60% of its maximum storage capacity. Preferably, the rate of increase of equivalent pressure exerted on the sidewall is less than 15 psi per cycle of hydriding and dehydriding over at least 45 of said cycles. More preferably, the rate of increase of equivalent pressure exerted on the sidewall is less than 15 psi per cycle of hydriding and dehydriding over at least 65 of the cycles. Preferably, the hydriding portion of each cycle includes the step of charging the hydrogen storage material to at least 75% of its maximum storage capacity. More preferably, the hydriding portion of each cycle includes the step of charging the hydrogen storage material to at least 90% of its maximum storage capacity.

In a third embodiment of the present invention, a hydrogen storage material occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 10 psi over at least 20 of the cycles, the hydriding portion of each of the cycles including the step of charging the hydrogen storage material to at least 60% of its maximum storage capacity. Preferably, the rate of increase of equivalent pressure exerted on the sidewall is less than 10 psi per cycle of hydriding and dehydriding over at least 45 of the cycles. More preferably, the rate of increase of equivalent pressure exerted on the sidewall is less than 10 psi per cycle of hydriding and dehydriding over at least 65 of the cycles. Preferably, the hydriding portion of each cycle includes the step of charging the hydrogen storage material to at least 75% of its maximum storage capacity. More preferably, the hydriding portion of each cycle includes the step of charging the hydrogen storage material to at least 90% of its maximum storage capacity.

### BRIEF DESCRIPTION OF THE DRAWINGS

FIG. 1, is a depiction of an embodiment of the hydrogen storage unit in accordance with the present invention.

FIG. 2, is a cross-sectional view of the embodiment of the present invention depicted in FIG. 1.

FIG. 3, is a depiction of a primary block in accordance with the present invention.

FIG. 4, is a plot showing the equivalent pressure at each strain gauge as a function of the number of cycles for the hydrogen storage unit in accordance with the present invention.

FIG. 5, is a plot showing the equivalent pressure at each strain gauge as a function of the number of cycles for a prior art hydrogen storage unit.

### DETAILED DESCRIPTION OF THE PREFERRED EMBODIMENTS OF THE INVENTION

In accordance with the present invention there is provided herein a metal hydride hydrogen storage unit. The metal hydride hydrogen storage unit may be modular in design allowing for assembly in prefabricated vessels. Through compartmentalization, the metal hydride hydrogen storage unit maintains a substantially uniform metal hydride powder density after repeated cycling. The design of the metal hydride hydrogen storage unit reduces the amount of stress applied on the interior of the hydrogen storage unit as a result of the expansion of the hydrogen storage alloy powder upon absorbing and storing hydrogen in metal hydride form. The metal hydride hydrogen storage unit may also be able to absorb a portion of the stress created by the expansion of the hydrogen storage alloy powder thereby further reducing the stress applied on interior of the hydrogen storage unit. The modular design of the metal hydride hydrogen storage unit also allows for assembly of the hydrogen storage unit using prefabricated pressure containment vessels.

The hydrogen storage unit generally comprises a pressure containment vessel at least partially filled with an hydrogen storage alloy powder. The hydrogen storage alloy powder preferably has a powder density less than or equal to 90% of the bulk (ingot) density of the hydrogen storage alloy. Other embodiments may utilize a hydrogen storage alloy powder having a powder density less than or equal to 75% or 60% of the bulk (ingot) density of the hydrogen storage alloy. The pressure containment vessel may be any type vessel capable of storing its contents under pressure. The pressure containment vessel may be any size or shape. Preferably, the pressure containment vessel may be cylindrical or spherical in shape. The hydrogen storage unit may further comprise a compartmentalization structure disposed within the interior of the pressure containment vessel. The compartmentalization structure compartmentalizes the interior of the vessel and houses at least a portion of the hydrogen storage alloy powder disposed within the pressure containment vessel.

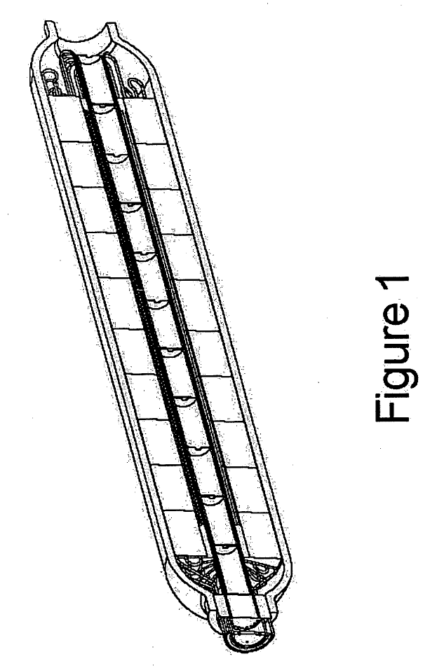

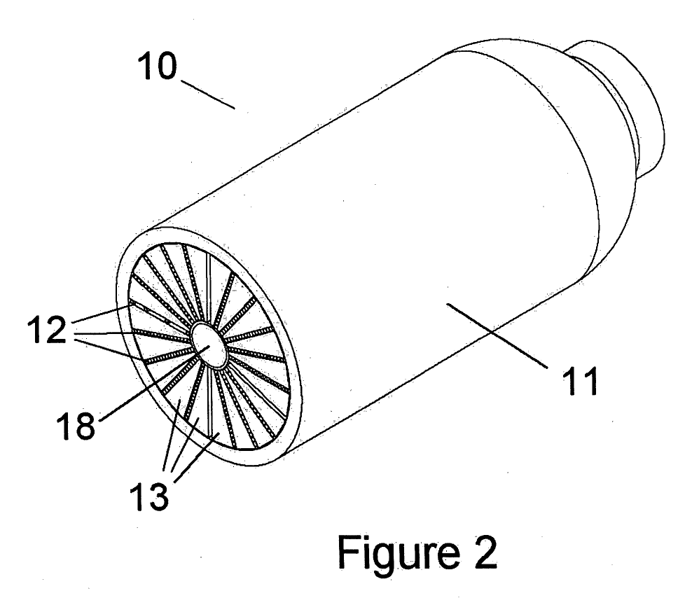

An embodiment of the hydrogen storage unit in accordance with the present invention is depicted in FIG. 1. A cross-sectional view of the embodiment of the present invention depicted in FIG. 1 is depicted in FIG. 2. The hydrogen storage unit 10 in accordance with the present invention generally comprises a pressure containment vessel 11 having a longitudinal axis and a plurality of cells 14 at least partially filled with a hydrogen storage alloy powder. The plurality of cells 14 are preferably radially disposed about the longitudinal axis of the pressure containment vessel. At least a portion of the plurality of cells 14 may be arranged into a plurality of primary modular blocks 13 radially disposed about the longitudinal axis of the pressure containment vessel. The hydrogen storage unit 10 may further comprise a plurality of fins 12, whereby each of the plurality of blocks 13 is disposed between two of the plurality of fins 12. The hydrogen storage unit 10 may include one or more heat exchanger tubes 15 disposed within the pressure containment vessel 11 for heating or cooling the hydrogen storage alloy powder contained within the cells of the hydrogen storage unit 10.

The pressure containment vessel 11 may be any vessel capable of containing a pressurized gas. The pressure containment vessel may be formed of low carbon steel, stainless steel, or aluminum. Preferably, the pressure containment vessel is from of low carbon A106B, which has negligible reactivity with the hydrogen stored within the pressure containment vessel, thus avoiding embrittlement of the pressure containment vessel during repeated cycling. The pressure containment vessel preferably has a cylindrical shape with a longitudinal axis. Preferably, the pressure containment vessel is seamless. The pressure containment vessel has a first opening at one end through which hydrogen enters and exits the pressure containment vessel. A heat transfer fluid may also enter and exit the heat exchanger tubes disposed inside the pressure containment vessel through the first opening. The pressure containment vessel may have a second opening on the end opposite the first opening such that hydrogen enters and exits the pressure containment vessel through the first opening and the heat transfer fluid enters and exits the heat exchanger tubes disposed inside the pressure containment vessel through the second opening. The first and second openings of the pressure containment vessel preferably have a diameter less than or equal to 50% of the interior diameter of the pressure containment vessel as required by the codes and standards of The American Society of Mechanical Engineers for pressure containment vessels. To provide the vessel with additional strength for high pressure operation, a fiber reinforced composite material such as glass or carbon fiber may be wound around the vessel to help prevent damage to the pressure containment vessel at high operating pressures.

Each of the plurality of cells 14 are at least partially filled with a hydrogen storage alloy powder which stores hydrogen in metal hydride form. The plurality of cells 14 are preferably positioned parallel to one another and are radially disposed about the longitudinal axis of the pressure containment vessel such that the top of each cell faces the interior wall of the pressure containment vessel and the bottom of each cell faces away from the interior wall of the pressure containment vessel toward the longitudinal axis of the pressure containment vessel. At least a portion of the cells may extend from an area proximate to the interior wall of the pressure containment vessel to an area proximate to the longitudinal axis of the pressure containment vessel. Each cell has an open top, an open bottom, and a cell wall. The cross-section of each cell may have a circular or polygonal configuration. The diameter of the cells is determined by the heat transfer requirements of the hydrogen storage unit. Preferably the height of each cell is greater than the diameter of the cell. The cells are preferably formed from a heat conductive material such as low carbon steel, stainless steel, copper, aluminum, or other conductive materials having negligible reactivity with the contents of the pressure containment vessel.

A porous filter material may be placed at the top and bottom of each cell to retain the hydrogen storage alloy powder within the cells. The porous filter material should be formed from a material having negligible reactivity with the stored hydrogen. Preferably, the porous filter material is a glass wool.

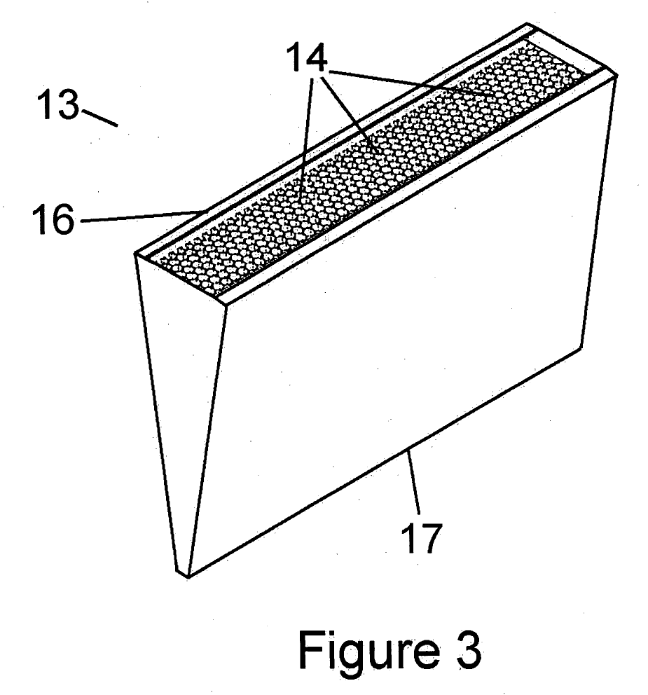

The plurality of cells 14 may be arranged into one or more primary blocks 13. Preferably, the one or more primary blocks are modular in design. The one or more primary blocks 13 may be radially disposed within the pressure containment vessel 11 about the longitudinal axis of the pressure containment vessel. A primary block 13 in accordance with the present invention is depicted in FIG. 3. The primary modular blocks may be in contact with and/or in thermal communication with the one or more fins and/or one or more heat exchanger tubes. Each primary block may be disposed between two of the plurality of fins 12. Each primary block 13 may have an open top 16 and an open bottom 17 which allows hydrogen to flow into and through the cells within each primary block. The primary blocks may have sides which may be solid or have holes allowing hydrogen to access the interior of the primary blocks. The primary blocks 13 preferably have a triangular or trapezoidal cross-section whereby the bottom of each primary block is narrower than the top of each primary block. The bottom of each primary block is preferably curved inward thereby creating a longitudinal channel about the longitudinal axis of the pressure containment vessel when the primary modular blocks are disposed in a radial manner about the longitudinal axis of the pressure containment vessel. The top of each primary block may be curved outward to better conform to the interior wall of the pressure containment vessel. The height of the primary modular blocks from top to bottom is preferably less than the diameter of the first or second opening of the pressure containment vessel thereby allowing for insertion of each of the one or more primary modular blocks into the pressure containment vessel through the first or second opening. When disposed in the pressure containment vessel, the top of each primary block is adjacent to the interior wall of the pressure containment vessel. Each of the primary modular blocks may extend the length of the interior of the pressure containment vessel or two or more primary modular blocks may be disposed adjacent to one another such that the adjacent primary modular blocks extend the length of the interior of the pressure containment vessel. The primary modular blocks are preferably constructed from a heat conductive material such as low carbon steel, stainless steel, copper, aluminum, or other conductive materials having negligible reactivity with the contents of the pressure containment vessel.

The plurality of cells and/or the primary modular blocks may be disposed within the pressure containment vessel in such a way as to form an axial channel 18 about the longitudinal axis of the pressure containment vessel. A second plurality of cells at least partially filled with a hydrogen storage alloy powder may be disposed in the axial channel 18. At least a portion of the second plurality of cells may be disposed in one or more secondary blocks 19 disposed in the axial channel 18. The second plurality of cells may be radially disposed about or parallel to the longitudinal axis of the pressure containment vessel. The one or more secondary blocks preferably have a cylindrical cross-section. Each secondary block may be formed from a plurality of radially disposed triangular or trapezoidal blocks containing at least a portion of the secondary plurality of cells. Each secondary block 19 may have an axial channel about the longitudinal axis of the cylindrical block allowing for hydrogen to flow through the pressure containment vessel. Preferably, the hydrogen storage alloy powder disposed within the axial channel has a higher packing density than the hydrogen storage alloy powder contained elsewhere in the pressure containment vessel. By providing a greater packing density for the hydrogen storage alloy powder disposed within the axial channel, the flow of hydrogen through the system may be directed toward the axial channel through mass transport. The mass transport of hydrogen within the system causes the hydrogen gas and hydrogen storage alloy powder to move toward the longitudinal axis of the pressure containment vessel away from the interior wall of the pressure containment vessel thereby reducing the stress on the interior wall of the pressure containment vessel.

The plurality of fins 12 located within the pressure containment vessel 11 compartmentalize and/or aid in heat transfer throughout the pressure containment vessel interior. The plurality of fins may be radially disposed about the longitudinal axis of the pressure containment vessel. Each of the heat fins may extend the length of the interior of the pressure containment vessel or two or more heat fins may be disposed with their edges adjacent to one another such that the adjacent fins extend throughout the length of the interior of the pressure containment vessel. The fins may be rectangular or square. The fins may be flat or have a grooved configuration. The height of the fins is preferably less than the diameter of the first or second opening of the pressure containment vessel thereby allowing insertion into the pressure containment vessel through the first or second opening. The plurality of fins are preferably constructed from a heat conductive material such as low carbon steel, stainless steel, copper, aluminum, or other conductive materials having negligible reactivity with the contents of the pressure containment vessel.

The one or more heat exchanger tubes 15 may be positioned adjacent to one or more of the fins 12 and/or one or more of the primary modular blocks 13 and/or secondary blocks 19. The heat exchanger tubes 15 and the fins 12 may be in direct contact and/or in thermal communication with each other. When using grooved fins, one or more of the heat exchanger tubes may reside within one or more of the grooves on the fins. The amount of heat exchanger tubing within the vessel is variant upon the amount of heat required to be added or removed from the vessel. The heat exchanger tubing is formed from a thermally conductive material. Preferably, the heat exchanger tubes are composed of stainless steel, copper, or aluminum. The heat exchanger tubes may be composed of other materials provided they have negligible reactivity within the system.

During operation, a heat transfer fluid flows through the heat exchanger tubes to remove heat from the hydrogen storage alloy powder to the outside environment during hydrogenation of the hydrogen storage alloy powder or add heat to the hydrogen storage alloy powder during dehydrogenation of the hydrogen storage alloy powder. The heat transfer fluid is preferably either ethylene glycol, water, or a mixture thereof, however, other liquids or gases may be used in accordance with the present invention.

When utilizing a single heat exchanger tube, the heat transfer fluid enters the vessel through a fluid inlet, enters the heat exchanger tube, and flows through the pressure containment vessel via the heat exchanger tube thereby heating or cooling the contents of the pressure containment vessel. After the fluid flows through the vessel via the heat exchanger tube, the fluid exits the pressure containment vessel through a fluid outlet.

When utilizing two or more heat exchanger tubes, the heat transfer fluid enters the vessel through a fluid inlet and flows into an inlet manifold which distributes the fluid to the two or more heat exchanger tubes within the vessel. Upon entering the two or more heat exchanger tubes, the fluid flows through the vessel via the heat exchanger tubes, thereby heating or cooling the contents of the pressure containment vessel. After the fluid flows through the pressure containment vessel via the two or more heat exchanger tubes, the fluid flows into a outlet manifold which combines the heat transfer fluid from each of the heat exchanger tubes into a single exit stream which flows out of the pressure containment vessel through a fluid outlet.

The hydrogen storage alloy powder contained within the plurality of cells may be one or more hydrogen storage alloys generally known to those in the art. The hydrogen storage alloys as used in accordance with the present invention may or may not be cycled prior to being placed in the pressure containment vessel.

Hydrogen storage alloys may be chosen from AB, A₂B, A₂B₇, AB₂, or AB₅ alloy systems, or combinations thereof. Such alloys may have a body centered cubic (BCC), face centered cubic (FCC), laves phase, C-14, or C-15 crystal structure. Examples of such alloys are Mg, Mg—Ni, Mg—Cu, Ti—Fe, Ti—Mn, Ti—Ni, Ti—V, Ti—Cr, Mm—Ni, Mm—Co alloy systems. The different hydrogen storage alloy systems provide differing characteristics such as hydrogen absorption capacity and reversibility based on temperature and pressure.

Of these materials, the Mg alloy systems can store relatively large amounts of hydrogen per unit weight of the storage material. To release the hydrogen stored within the alloy heat energy must be supplied, because of the low hydrogen dissociation equilibrium pressure of the alloy at room temperature. Moreover, release of hydrogen can be made, only at a high temperature of over 250° C. along with the consumption of large amounts of energy. Different types of magnesium based hydrogen storage alloys are fully disclosed in U.S. Pat. No. 6,193,929, to Ovshinsky et al. entitled “High Storage Capacity Alloys Enabling A Hydrogen-Based Ecosystem”, the disclosure of which is hereby incorporated by reference.

The rare-earth (Misch metal) alloys typically can efficiently absorb and release hydrogen at room temperature, based on the fact that it has a hydrogen dissociation equilibrium pressure on the order of several atmospheres at room temperature. The drawbacks to rare earth alloys are that their hydrogen-storage capacity per unit weight is lower than any other hydrogen-storage materials and they are relatively expensive.

The Ti—Fe alloy system, which has been considered as a typical and superior material of the titanium alloy systems, has the advantages that it is relatively inexpensive and the hydrogen dissociation equilibrium pressure of hydrogen is several atmospheres at room temperature. However, since it requires a high temperature of about 350° C. and a high pressure of over 30 atmospheres for initial hydrogenation. Also, it has a hysteresis problem which hinders the complete release of hydrogen stored therein. The Ti—Fe alloy is also easily poisoned by moisture, which will be present within the heating pack.

The Ti—Mn alloy has excellent ambient temperature kinetics and plateau pressures. The Ti—Mn alloy system has been reported to have a high hydrogen-storage efficiency and a proper hydrogen dissociation equilibrium pressure, since it has a high affinity for hydrogen and low atomic weight to allow large amounts of hydrogen-storage per unit weight.

### EXAMPLE

In this example, a beneficial reduction in stress at the interior wall of a pressure containment vessel of a hydrogen storage unit according to the present invention is demonstrated. The hydrogen storage unit includes a pressure containment vessel having an outside diameter of approximately 3.5 inches and a length of approximately 12 inches. The vessel has a central portion that is cylindrically shaped and upper and lower end portions that are rounded. One of the end portions was equipped with an inlet opening to permit access to the interior of the vessel and to enable the introduction of hydrogen gas into the vessel.

The interior of the vessel was equipped with radially disposed cells for supporting and housing a hydrogen storage alloy powder. The cells were formed as corrugations in metal disks that were inserted into the vessel with centers aligned along the central longitudinal axis of the vessel. Both ends of each of the radially disposed cells were open to permit the flow of hydrogen gas through the cell. The end of the cell closest to the exterior wall of the vessel shall be referred to as the top or top end of the cell and the end of the cell closest to the central longitudinal axis of the vessel shall be referred to as the bottom or bottom end of the cell. The diameters of the metal disks were uniform and each was less than the inside diameter of the pressure vessel so that an annular gap was present between the exterior wall of the vessel and the top ends of the radially disposed cells. Heat generated inside the vessel during hydride formation exited through the vessel wall as the vessel was cooled externally.

The portion of the exterior wall fronted by the top ends of the radially disposed cells shall be referred to herein as the sidewall of the pressure containment vessel. The sidewall extends longitudinally between the bottom-most and top-most corrugated metal disks used to house the hydrogen storage alloy powder. The sidewall thus corresponds to the portion of the exterior wall that surrounds the a majority if not all of the volume occupied by hydrogen storage alloy powder. In this example, the sidewall has a cylindrical shape. The exterior wall of the vessel further includes a top wall that surrounds the volume above the volume occupied by the hydrogen storage alloy powder and a bottom wall that surrounds the volume below the volume occupied by the hydrogen storage alloy powder.

An AB₂-type hydrogen storage alloy having a composition Ti_{29.5}Zr₄Cr₁₇V₈Mn_{39.93}Fe_{1.43}Al_{0.14}. was distributed into the cells. The hydrogen storage alloy had a bulk (ingot) density of 6.4 g/cm³. The hydrogen storage alloy was formed into a sieved powder that had a powder density of 4.2 g/cm³. The hydrogen storage alloy powder was added uniformly to the different cells. The total amount of hydrogen storage alloy powder added to the vessel was such that the volumetric density of the hydrogen storage alloy powder in the interior of the vessel was approximately 3 g/cm³, where the volumetric density is based on the open volume within the interior of the vessel available for the placement of the hydrogen storage alloy powder. This volumetric density corresponds to a filling of the available interior volume of the vessel with the hydrogen storage alloy powder to a level of approximately 74%. As used herein, available interior volume is defined as the interior volume of the pressure containment vessel that is not occupied by structures disposed inside the pressure containment vessel and is available to be occupied by the hydrogen storage alloy powder.

As described hereinabove, comminution or decrepitation of the hydrogen storage alloy powder can lead to the development of excess stress at the interior wall of a hydrogen storage container. If left unchecked, the excess stress can increase over multiple hydriding-dehydriding cycles and reach levels sufficient to rupture the vessel wall, thus causing catastrophic failure. In order to determine wall stresses in this experiment, strain gauges were placed at 20 different positions along the sidewall of the vessel. Measurements were limited to the cylindrical sidewall because the top ends of the radially disposed cells faced the sidewall. The strain gauges were circumferentially disposed at different longitudinal positions on the cylindrical sidewall. One group of four strain gauges was placed at each of five longitudinal positions. The gauges within each group of four at each longitudinal position were equally spaced around the circumference. In the longitudinal direction, the circumferential groups of strain gauges were separated by uniformly and the full longitudinal extent of the sidewall was sampled.

The objective of this experiment is to demonstrate a reduction in stress at the interior wall of the pressure containment vessel upon repeated cycles of hydriding and dehydriding. In order to achieve this objective, strain measurements as a function of the gas pressure of the vessel were completed. Separate experiments with two different gases were undertaken. In a first set of experiments, the vessel was pressurized with an inert gas that is not absorbed by the hydrogen storage alloy powder loaded into the vessel. The vessel was pressurized to several different pressures and at each pressure, a strain measurement by each of the 20 strain gauges was recorded. From these measurements, a plot of strain as a function of pressure was obtained. Measurements were limited to the elastic regime and the plot showed the expected linear behavior over the range of pressures considered.

In a second set of experiments, the vessel was pressurized with hydrogen and the strain measurements were repeated. Any difference in strain between charging the vessel with an inert gas relative to hydrogen gas at a given filling pressure is a consequence of the strain effect associated with the absorption of hydrogen by the hydrogen storage alloy powder. Because of hydrogen absorption, the strain measured when charging the vessel with hydrogen is higher than the strain measured when charging the vessel with the same pressure of an inert gas. To express the stress effect associated with hydrogen absorption, we report a parameter that we term an equivalent pressure. The equivalent pressure is the increment in pressure, relative to the pressure of the hydrogen-charged vessel, needed to increase the strain of a vessel charged with inert gas-charged to the strain measured for the hydrogen-charged vessel. If, for example, the strain measured at a particular strain gauge at a particular charging pressure P is S when the vessel is filled with an inert gas and S+ΔS when the vessel is filled with hydrogen, the equivalent pressure is ΔP where P+ΔP is the pressure needed to achieve a strain of S+ΔS at the strain gauge in the vessel charged with the inert gas.

Measurements of the equivalent pressure associated with hydrogen storage were completed over multiple cycles of hydriding and dehydriding. In the hydriding step of the cycle, the vessel was charged with hydrogen to a pressure of about 300 psi. This pressure was chosen so that the hydrogen storage alloy powder would reach a nearly fully hydrided (over 90%) condition of about 1.8 weight percent absorbed hydrogen. After charging, the strain was measured at each of the 20 strain gauges and recorded. The pressure of the vessel was subsequently reduced back to ambient in a dehydriding step by releasing hydrogen. The cycle comprising the hydriding and dehydriding steps was repeated multiple times and strain measurements at each of the 20 strain gauges were completed following each hydriding step. The strain measurements for each cycle were used to determine an equivalent pressure for the cycle. As described hereinabove, cycling a hydrogen storage alloy powder over repeated hydriding and dehydriding steps leads to comminution or decrepitation of the hydrogen storage alloy powder. By measuring the equivalent pressure over many cycles, the effect of comminution on wall stress at different location on the vessel wall can be determined and the beneficial effect of the instant pressure containment vessel can be demonstrated.

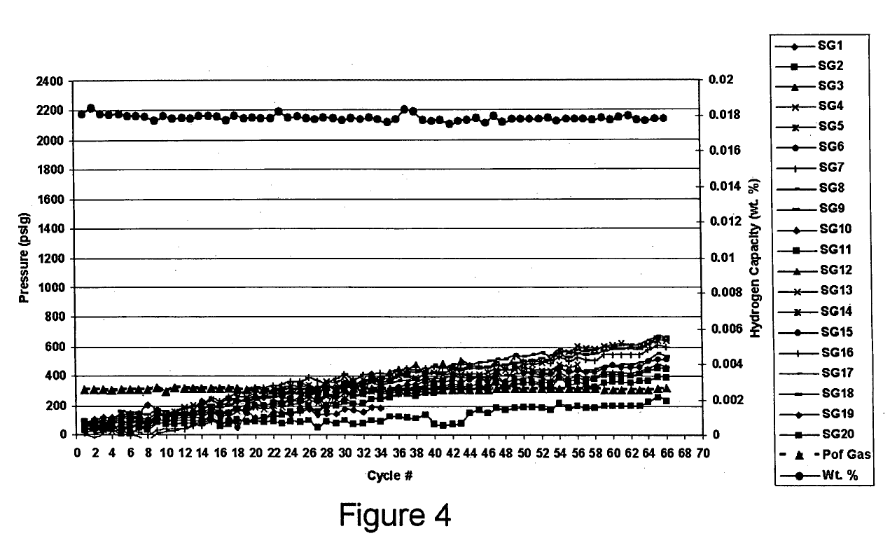

The results of the cycling experiment are presented in FIG. 4, which shows the equivalent pressure at each strain gauge as a function of the number of cycles. Also shown is the hydrogen storage capacity (top-most curve) and the charging pressure of hydrogen gas (set of triangular symbols corresponding to 300 psi). The hydrogen storage capacity curve is referred to the right-side ordinate axis (labeled “hydrogen capacity”), while all other data curves are referred to the left-side ordinate axis (labeled “pressure”). A symbol legend is presented in the far right portion of FIG. 4. “SG” denotes “strain gauge” and the numbers designate the particular one of the 20 strain gauges.

As is to be expected, the data of FIG. 4 show an increase in equivalent pressure (and hence an increase in wall stress) upon repeated cycling due to comminution. Two features of the data, however, are noteworthy. First, the rate of increase of the equivalent pressure with increasing cycle number is gradual. The average value of the equivalent pressure increases from 0 psi before the first cycle to only approximately 440 psi after 66 cycles of hydriding to 300 psi and dehydriding. This corresponds to an increase of less than 7 psi per cycle in the average value of the equivalent pressure over the sidewall of the vessel. The increase in the average equivalent pressure per cycle amounts to less than 3% of the charging pressure of hydrogen in the vessel.

Second, the range in equivalent pressure across the 20 strain gauges increases only gradually upon repeated cycling. Before the first cycle, there is no spread in the reading of the strain gauges and the range of equivalent pressure is zero. After 66 cycles of hydriding to 300 psi and dehydriding, the equivalent pressures obtained from the 20 strain gauges extend from about 230 psi to about 650 psi to provide a total range of about 420 psi. This corresponds to an increase in the range of equivalent pressures across the sidewall of the vessel of less than 7 psi per cycle. The increase in range of equivalent pressure per cycle amounts to less than 3% of the charging pressure of hydrogen in the vessel.

In order to demonstrate the advantages of the instant pressure containment vessel including radial cells for housing the hydrogen storage alloy powder, a control experiment was completed using a vessel having longitudinally disposed cells for housing the hydrogen storage alloy powder. The cell design used for the control was a honeycomb design similar to that described in U.S. Pat. No. 6,709,497; the disclosure of which is incorporated by reference herein. Experiments to determine the variation of the equivalent pressure of the control vessel with the number of cycles of hydriding and dehydriding were completed in a manner analogous to the experiments described hereinabove for the instant pressure containment vessel. The same hydrogen storage alloy powder with the same powder and volumetric density was used and the hydriding step included pressurization to 300 psi to insure a nearly fully hydrided (over 90%) condition for the hydrogen storage alloy powder. Strain gauges were placed at 20 positions along the cylindrical sidewall of the control vessel in positions corresponding to those used in the experiments of the instant vessel design and the equivalent pressure at each strain gauge was measured as described hereinabove.

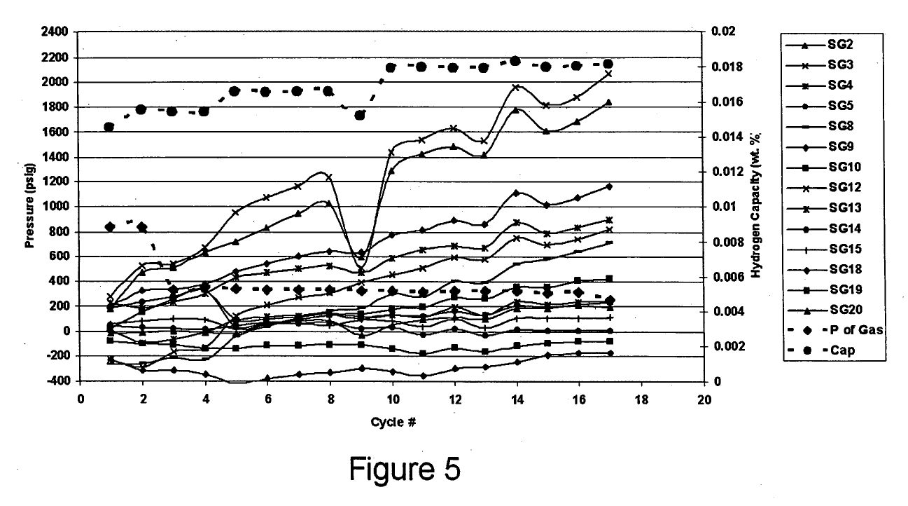

The results of the equivalent pressure measurements for the control vessel are shown in FIG. 5. The equivalent pressure of the cylindrical sidewall at each of the 20 positions corresponding to the locations of the strain gauges is shown as a function of the number of cycles of hydriding and dehydriding. Also shown are the charging pressure of the gas (˜300 psi, except for the first two cycles (where initial transient effects were present)) and the hydrogen storage capacity of the hydrogen storage alloy powder (top curve). Relative to the results shown in FIG. 4 for the design of the instant invention, the results shown in FIG. 5 demonstrate a much more pronounced increase in both the equivalent pressure and the range of equivalent pressures per cycle of hydriding and dehydriding. The experiment was terminated after only 17 cycles due to the tremendous increase in the equivalent pressure at several of the strain gauges. After 17 cycles, the maximum equivalent pressure was over 2000 psi and the range of equivalent pressures was also over 2000 psi. The much lower increases in both the average equivalent pressure and range of equivalent pressures for the instant design are evident.

The foregoing example is illustrative of the instant invention and the beneficial reduction in wall stress and equivalent pressure that it provides. In one embodiment, the rate of increase of the average equivalent pressure over the sidewall of the vessel is less than 25 psi per cycle of hydriding and dehydriding when the volume available for the hydrogen storage alloy powder is filled 70% or more. Within this embodiment, it is preferred that the stated less than 25 psi per cycle increase in equivalent pressure persists for at least 20 cycles of hydriding and dehydriding. In a more preferred embodiment, the stated less than 25 psi per cycle increase in equivalent pressure persists for at least 45 cycles of hydriding and dehydriding. In a most preferred embodiment, the stated less than 25 psi per cycle increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a preferred embodiment, the rate of increase of the average equivalent pressure over the sidewall of the vessel is less than 15 psi per cycle of hydriding and dehydriding when the volume available for the hydrogen storage alloy powder is filled 70% or more. Within this embodiment, it is preferred that the stated less than 15 psi per cycle increase in equivalent pressure persists for at least 20 cycles of hydriding and dehydriding. In a more preferred embodiment, the stated less than 15 psi per cycle increase in equivalent pressure persists for at least 45 cycles of hydriding and dehydriding. In a most preferred embodiment, the stated less than 15 psi per cycle increase in equivalent pressure persists for at least 6.5 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a more preferred embodiment, the rate of increase of the average equivalent pressure over the sidewall of the vessel is less than 10 psi per cycle of hydriding and dehydriding when the volume available for the hydrogen storage alloy powder is filled 70% or more. Within this embodiment, it is preferred that the stated less than 10 psi per cycle increase in equivalent pressure persists for at least 20 cycles of hydriding and dehydriding. In a more preferred embodiment, the stated less than 10 psi per cycle increase in equivalent pressure persists for at least 45 cycles of hydriding and dehydriding. In a most preferred embodiment, the stated less than 10 psi per cycle increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a still more preferred embodiment, the rate of increase of the average equivalent pressure over the sidewall of the vessel is less than 7 psi per cycle of hydriding and dehydriding when the volume available for the hydrogen storage alloy powder is filled 70% or more. Within this embodiment, it is preferred that the stated less than 7 psi per cycle increase in equivalent pressure persists for at least 20 cycles of hydriding and dehydriding. In a more preferred embodiment, the stated less than 7 psi per cycle increase in equivalent pressure persists for at least 45 cycles of hydriding and dehydriding. In a most preferred embodiment, the stated less then 7 psi per cycle increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In one embodiment, the rate of increase of the average equivalent pressure over the sidewall of the vessel is less than 10% of the charging pressure of hydrogen per cycle of hydriding and dehydriding when the volume available for the hydrogen storage alloy powder is filled 70% or more. Within this embodiment, it is preferred that the stated less than 10% per cycle increase in equivalent pressure persists for at least 20 cycles of hydriding and dehydriding. In a more preferred embodiment, the stated less than 10% increase in equivalent pressure persists for at least 45 cycles of hydriding and dehydriding. In a most preferred embodiment, the stated less than 10% increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a preferred embodiment, the rate of increase of the average equivalent pressure over the sidewall of the vessel is less than 5% of the charging pressure of hydrogen per cycle of hydriding and dehydriding when the volume available for the hydrogen storage alloy powder is filled 70% or more. Within this embodiment, it is preferred that the stated less than 5% increase in equivalent pressure persists for at least 20 cycles of hydriding and dehydriding. In a more preferred embodiment, the stated less than 5% increase in equivalent pressure persists for at least 45 cycles of hydriding and dehydriding. In a most preferred embodiment, the stated less than 5% increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a more preferred embodiment, the rate of increase of the average equivalent pressure over the sidewall of the vessel is less than 3% of the charging pressure of hydrogen per cycle of hydriding and dehydriding when the volume available for the hydrogen storage alloy powder is filled 70% or more. Within this embodiment, it is preferred that the stated less than 3% increase in equivalent pressure persists for at least 20 cycles of hydriding and dehydriding. In a more preferred embodiment, the stated less than 3% increase in equivalent pressure persists for at least 45 cycles of hydriding and dehydriding. In a most preferred embodiment, the stated less than 3% increase in equivalent pressure persists for at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a preferred embodiment, the range of equivalent pressures present across the sidewall of the pressure containment vessel is less than 1000 psi after at least 20 cycles of hydriding and dehydriding when the volume available for the hydrogen storage alloy powder is filled 70% or more. In a more preferred embodiment, the range of equivalent pressures is less than 1000 psi after at least 45 cycles of hydriding and dehydriding. In a most preferred embodiment, the range of equivalent pressures is less than 1000 psi after at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a more preferred embodiment, the range of equivalent pressures present across the sidewall of the pressure containment vessel is less than 750 psi after at least 20 cycles of hydriding and dehydriding when the volume available for the hydrogen storage alloy powder is filled 70% or more. In a more preferred embodiment, the range of equivalent pressures is less than 750 psi after at least 45 cycles of hydriding and dehydriding. In a most preferred embodiment, the range of equivalent pressures is less than 750 psi after at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a preferred embodiment, the range of equivalent pressures present across the sidewall of the pressure containment vessel is less than 500 psi after at least 20 cycles of hydriding and dehydriding when the volume available for the hydrogen storage alloy powder is filled 70% or more. In a more preferred embodiment, the range of equivalent pressures is less than 500 psi after at least 45 cycles of hydriding and dehydriding. In a most preferred embodiment, the range of equivalent pressures is less than 500 psi after at least 65 cycles of hydriding and dehydriding. Within this embodiment, it is preferred that the hydrogen storage alloy powder is hydrided to at least 60% of its maximum storage capacity. In a more preferred embodiment, the hydrogen storage alloy powder is hydrided to at least 75% of its maximum storage capacity. In a most preferred embodiment, the hydrogen storage alloy powder is hydrided to at least 90% of its maximum storage capacity.

In a preferred embodiment of the present invention, a hydrogen storage alloy powder occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 25 psi over at least 20 of the cycles, the hydriding portion of each of the cycles including the step of charging said hydrogen storage alloy powder to at least 60% of its maximum storage capacity. Preferably, the rate of increase of equivalent pressure exerted on the sidewall is less than 25 psi per cycle of hydriding and dehydriding over at least 45 of the cycles. More preferably, the rate of increase of equivalent pressure exerted on the sidewall is less than 25 psi per cycle of hydriding and dehydriding over at least 65 of the cycles. Preferably, the hydriding portion of each cycle includes the step of charging the hydrogen storage alloy powder to at least 75% of its maximum storage capacity. More preferably, the hydriding portion of each cycle includes the step of charging the hydrogen storage alloy powder to at least 90% of its maximum storage capacity.

In a more preferred embodiment of the present invention, a hydrogen storage alloy powder occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 15 psi over at least 20 of the cycles, the hydriding portion of each of the cycles including the step of charging said hydrogen storage alloy powder to at least 60% of its maximum storage capacity. Preferably, the rate of increase of equivalent pressure exerted on the sidewall is less than 15 psi per cycle of hydriding and dehydriding over at least 45 of said cycles. More preferably, the rate of increase of equivalent pressure exerted on the sidewall is less than 15 psi per cycle of hydriding and dehydriding over at least 65 of the cycles. Preferably, the hydriding portion of each cycle includes the step of charging the hydrogen storage alloy powder to at least 75% of its maximum storage capacity. More preferably, the hydriding portion of each cycle includes the step of charging the hydrogen storage alloy powder to at least 90% of its maximum storage capacity.

In a most preferred embodiment of the present invention, a hydrogen storage alloy powder occupies at least 60% of the available interior volume of the pressure containment vessel, preferably 70% of the available interior volume, and most preferably 80% of the available interior volume. Upon cycling between hydriding and dehydriding, the rate of increase in the average equivalent pressure exerted on the sidewall is less than 10 psi over at least 20 of the cycles, the hydriding portion of each of the cycles including the step of charging the hydrogen storage alloy powder to at least 60% of its maximum storage capacity. Preferably, the rate of increase of equivalent pressure exerted on the sidewall is less than 10 psi per cycle of hydriding and dehydriding over at least 45 of the cycles. More preferably, the rate of increase of equivalent pressure exerted on the sidewall is less than 10 psi per cycle of hydriding and dehydriding over at least 65 of the cycles. Preferably, the hydriding portion of each cycle includes the step of charging the hydrogen storage alloy powder to at least 75% of its maximum storage capacity. More preferably, the hydriding portion of each cycle includes the step of charging the hydrogen storage alloy powder to at least 90% of its maximum storage capacity.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A hydrogen storage unit comprising:
a pressure containment vessel;
an hydrogen storage alloy powder occupying at least 60% the available interior volume of said pressure containment vessel;
wherein the rate of increase in the average equivalent pressure exerted on the interior wall of said pressure containment vessel is less than 25 psi per cycle of hydriding and dehydriding over at least 20 cycles, said hydrogen storage alloy powder being charged to at least 60% of its maximum hydrogen storage capacity during each hydriding cycle.

2. The hydrogen storage unit of claim 1, wherein said rate of increase of equivalent pressure exerted on the interior wall of said pressure containment vessel is less than 25 psi per cycle of hydriding and dehydriding over at least 45 of said cycles.

3. The hydrogen storage unit of claim 1, wherein said rate of increase of equivalent pressure exerted on the interior wall of said pressure containment vessel is less than 25 psi per cycle of hydriding and dehydriding over at least 65 of said cycles.

4. The hydrogen storage unit of claim 1, wherein said hydriding portion of each cycle includes the step of charging said hydrogen storage alloy powder to at least 75% of its maximum storage capacity.

5. The hydrogen storage unit of claim 1, wherein said hydriding portion of each cycle includes the step of charging said hydrogen storage alloy powder to at least 90% of its maximum storage capacity.

6. The hydrogen storage unit of claim 1, wherein said rate of increase in the average equivalent pressure is less than 15 psi per cycle.

7. The hydrogen storage unit of claim 6, wherein said rate of increase of equivalent pressure exerted on the interior wall of said pressure containment vessel is less than 15 psi per cycle of hydriding and dehydriding over at least 45 of said cycles.

8. The hydrogen storage unit of claim 6, wherein said rate of increase of equivalent pressure exerted on the interior wall of said pressure containment vessel is less than 15 psi per cycle of hydriding and dehydriding over at least 65 of said cycles.

9. The hydrogen storage unit of claim 6, wherein said hydriding portion of each cycle includes the step of charging said hydrogen storage alloy powder to at least 75% of its maximum storage capacity.

10. The hydrogen storage unit of claim 1, wherein said hydriding portion of each cycle includes the step of charging said hydrogen storage alloy powder to at least 90% of its maximum storage capacity.

11. The hydrogen storage unit of claim 1, wherein said rate of increase in the average equivalent pressure is less than 10 psi per cycle.

12. The hydrogen storage unit of claim 11, wherein said rate of increase of equivalent pressure exerted on the interior wall of said pressure containment vessel is less than 10 psi per cycle of hydriding and dehydriding over at least 45 of said cycles.

13. The hydrogen storage unit of claim 11, wherein said rate of increase of equivalent pressure exerted on the interior wall of said pressure containment vessel is less than 10 psi per cycle of hydriding and dehydriding over at least 65 of said cycles.

14. The hydrogen storage unit of claim 11, wherein said hydriding portion of each cycle includes the step of charging said hydrogen storage alloy powder to at least 75% of its maximum storage capacity.

15. The hydrogen storage unit of claim 11, wherein said hydriding portion of each cycle includes the step of charging said hydrogen storage alloy powder to at least 90% of its maximum storage capacity.

16. The hydrogen storage unit according to claim 1, wherein said hydrogen storage alloy powder occupies at least 70% of the available interior volume of said pressure containment vessel.

17. The hydrogen storage unit according to claim 1, wherein said hydrogen storage alloy powder occupies at least 80% of the available interior volume of said pressure containment vessel.

18. The hydrogen storage unit according to claim 1, wherein said pressure containment vessel comprises a compartmentalization structure disposed therein, said hydrogen storage vessel housing at least a portion of said hydrogen storage alloy powder.

19. The hydrogen storage unit according to claim 1, wherein said pressure containment vessel comprises a longitudinal axis and a sidewall parallel to said longitudinal axis.

20. The hydrogen storage unit according to claim 19, wherein said pressure containment vessel comprises a compartmentalization structure disposed therein, said hydrogen storage vessel containing at least a portion of said hydrogen storage alloy powder.

21. The hydrogen storage unit according to claim 1, wherein said hydrogen storage alloy powder having a powder density of less than 90% of the bulk hydrogen storage alloy density.
